(19) United States
(12) Patent Application Publication
(10) Pub. No.: US 2004/0203652 A1
(43) Pub. Date: Oct. 14, 2004

(54) METHOD AND DEVICE FOR DTMF WIRELESS HANDSET BASED TEXT MESSAGING

(76) Inventor: Gao Yan, San Diego, CA (US)

Correspondence Address: NAIPO (NORTH AMERICA INTERNATIONAL PATENT OFFICE), P.O. BOX 506, MERRIFIELD, VA, 22116, US

(21) Appl. No.: 10/248,991

(22) Filed: Mar. 7, 2003

(51) Int. Cl. H04M 1/00

(52) U.S. Cl. 455/414.1; 455/566

(57) ABSTRACT

A method includes first selecting a text character with a first mobile phone, and then transmitting via radio a series of dual tone multi-frequency (DTMF) tones corresponding to the selected character from the first mobile phone to a second mobile phone. At the second mobile phone, the method includes correlating the series of received DTMF tones to the selected character, and displaying the selected character on a display device. A DTMF decoder is used to correlate DTMF tones to text character referencing a character encoding scheme stored in the first and second mobile phones. The method allows quick and reliable text messaging through DTMF tone signals over a voice channel.

### BACKGROUND OF INVENTION

1. Field of the Invention

The present invention relates to digital electronics, and more specifically, to wireless device based text messaging.

2. Description of the Prior Art

In the past, telephone systems have been primarily used for voice transmission, however, with the advent of digital telephone systems, such as modern mobile phones having versatile liquid crystal displays (LCDs), text messaging has become feasible. Mobile phone text messaging is popularly used in situations where talking is indiscreet or inconvenient, and can also be used by those with hearing or speaking disabilities.

Several state of the art technologies are used to provide text messaging in mobile phones, with the wireless application protocol (WAP) and short message service (SMS) being two of the most common. These systems require a separate digital data channel and base station cooperation in order to function, specifically, a text message must be transmitted to a base station and processed and routed by a message center across a separate data channel. From a user”s perspective, there are certain disadvantages to WAP and SMS. First, the message center causes significant delays in the transmission of the text message; and during times of high data traffic the text message may end up undelivered. And second, costs for providing the message center and supporting the digital data channel typically result in both WAP and SMS being subscription or fee-based services. Both the WAP and SMS systems require a significant amount of hardware, and associates costs, over that required for ordinary voice communication.

The prior art systems of communicating text messages between mobile phones suffer from inconvenient delays and are overly costly to service providers and users. Thus, an improved text messaging system is required.

### SUMMARY OF INVENTION

It is therefore a primary objective of the present invention to provide a method and device for communicating a text message encoded as dual tone multi-frequency (DTMF) tones between communications devices, such as mobile phones, over a voice channel.

Briefly summarized, a method according to the present invention includes first selecting a text character with a first communications device, and then transmitting via radio a series of DTMF tones corresponding to the selected character from the first communications device to a second communications device. Each character of a character set is corresponded to a unique series of DTMF tones by a predetermined character encoding scheme. At the second communications device, the method further includes correlating the series of received DTMF tones to the selected character, and displaying the selected character on a display device.

According to the present invention, a communications device includes an input device, a DTMF encoder connected to the input device, a radio transmitter connected to the DTMF encoder, a radio receiver, a DTMF decoder connected to the radio receiver, and a display device connected to the DTMF decoder. The DTMF encoder generates a series of DTMF tones according to at least a character input at the input device and forwards the series of DTMF tones to the radio transmitter, which modulates them into a radio signal and transmits the radio signal to a cellular base station or directly to another communications device. The radio receiver demodulates DTMF tones from other radio signals received from the cellular base station or directly from other communications devices. The DTMF decoder decodes the DTMF tones into characters that are displayed with the display device.

It is an advantage of the present invention that encoding text messages over a voice channel used for normal conversation results is little delay in text message communication.

It is a further advantage of the present invention that text messages can be simultaneously communicated between communications devices as they are typed or sent in a longer stream of characters from one communications device to another.

It is a further advantage that the present invention uses minimal specialized hardware such as message centers or electronics required to support a separate digital channel.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a mobile phone system according to the present invention.

FIG. 2 is a block diagram of the mobile phones of FIG. 1 according to the preferred embodiment of the present invention.

FIG. 3 is a flowchart of a method of communicating a text message between the mobile phones shown in FIG. 1.

### DETAILED DESCRIPTION

The dual tone multi-frequency (DTMF) system is widely used in modern telephone systems, being originally developed and best suited for voice channel communication. As shown in Table 1, the DTMF system requires that two tones (a high tone and a low tone) be combined to produce a single tone representing each of the common telephonic symbols. For example, to encode the number “5” tones of 1336 and 770 Hertz would be combined at appropriate decibel levels. The letter codes A-D are not widely used in public applications, however, they are still supported in commonly available DTMF encoders and decoders. Currently, the DTMF system is used in dialing telephone numbers and communicating with automated services when entering information such as passwords and account numbers.

TABLE 1
DTMF

| | 1209 Hz | 1336 Hz | 1477 Hz | 1633 Hz |
|---|---|---|---|---|
| 697 Hz | 1 | 2 | 3 | A |
| 770 Hz | 4 | 5 | 6 | B |
| 852 Hz | 7 | 8 | 9 | C |
| 941 Hz | * | 0 | # | D |

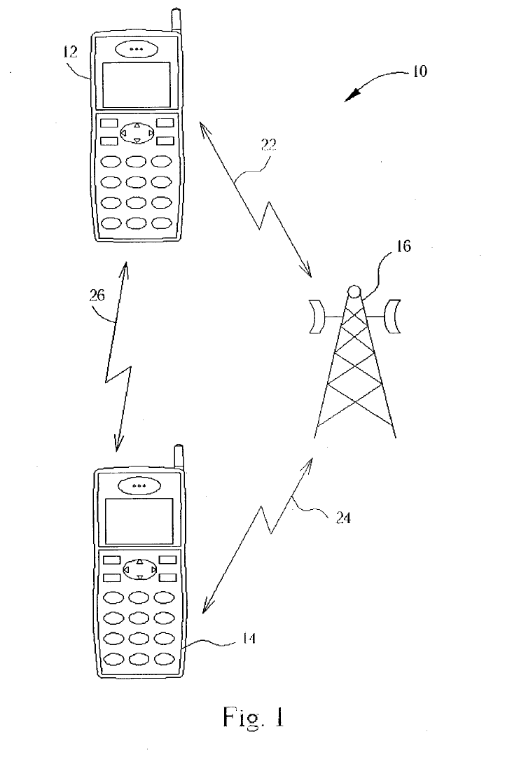

Please refer to FIG. 1 illustrating a mobile phone system 10 according to the present invention. The phone system 10 includes two identical mobile phones 12, 14 communicating through a base station 16 via radio transmissions 22, 24. According to the present invention, the base station 16 is not required if the mobile phones 12, 14 are capable of communicating directly via radio transmission 26. Though the base station 16 or independently, the mobile phones 12, 14 are capable of establishing a full-duplex voice connection, allowing two users to talk and listen simultaneously.

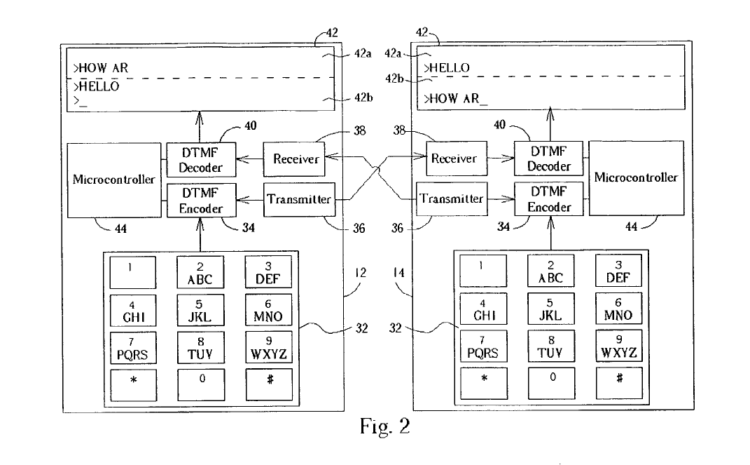

A block diagram of the mobile phones 12, 14 showing text messages being communicated is illustrated in FIG. 2. The mobile phones 12, 14 each comprise a 12-key keypad 32, a DTMF encoder 34 connected to the keypad 32, and a radio transmitter 36 connected to the DTMF encoder 34 for entering and transmitting a text message. The mobile phones 12, 14 each further comprise a radio receiver 38, a DTMF decoder 40 connected to the radio receiver 38, and a liquid crystal display (LCD) 42, nominally divided into two regions 42a and 42b, for receiving and displaying a text message. Lastly, the mobile phones 12, 14 each include a processor-memory combination or microcontroller 44 for storing a character encoding and control scheme including characters used to generate a text message and corresponding sets of DTMF tones. The memory of the microcontroller 44 can be a random-access memory, a read-only memory, a flash memory, or a similar well known digital memory device. The microcontroller 44 further coordinates and supports the other components (some connection lines are omitted from FIG. 2 for clarity) and provides well-know ancillary functions such as a system clock, dialing program, and text input program.

The keypad 32 allows a user to enter an alphanumeric or symbolic character and is capable of outputting a character code, such as a binary representation of an ASCII standard character code, to the DTMF encoder 34. A multitude of characters (A-z, 0-9, and symbols and punctuation) can be entered with the keypad 32 using any one of a number of well-known keypad entry methods. A common keypad entry method, for example, involves pressing a key repeatedly until the desired character is selected and then finalizing the selection by pressing another key or waiting for a time-out. Other keypad entry methods are more advanced and take a predictive approach, anticipating the next character to be entered based on previous characters entered. The keypad entry method is provided by the microcontroller 44 of the mobile phones 12, 14, and once a character is selected with the keypad 32, a corresponding character code is output to the DTMF encoder 34.

The DTMF encoder 34 receives character codes from the keypad 32 and generates corresponding DTMF tones referencing the character encoding and control scheme stored in the microcontroller 44. The DTMF encoder 34 outputs the DTMF tones to the radio transmitter 36.

Table 2 outlines the character encoding and control scheme stored in the microcontroller 44, a complete table not being listed in the interest of brevity. Referring to Table 1, to translate ASCII code to DTMF code, the character encoding and control scheme assigns the corresponding numerical values to tones “0-9”, a value of “10” to the “A” tone, a value of “11” to the “B” tone, and a value of “12” to the C tone, the “D” tone being a control tone. Additionally, the “*” tone designates characters 0-127 of the ASCII code and the “#” tone designates characters 128-255 of a suitable ASCII extended character set. For example, the letter “A” is represented by a tone series “*65”, and the letter “p” by a tone series “*B2” (ASCII code for “p” being 112, B=11, 11*10+2=112). In this way, the standard ASCII character set, an extended ASCII character set, and a set of controls can be represented by a series of DTMF tones.

TABLE 2

| | | DTMF | | | |
|---|---|---|---|---|---|
| Function | ASCII | Code | Function | ASCII | DTMF Code |
| Req. connect | — | 0DA | . . . | . . . | . . . |
| Ack. connect | — | 0DB | “A” | 65 | *65 |
| Req. disconnect | — | *D0 | “B” | 66 | *66 |
| Ack. disconnect | — | *D1 | . . . | . . . | . . . |
| Cursor left | — | A | “y” | 121 | *C1 |
| Cursor right | — | B | “z” | 122 | *C2 |
| Backspace | — | C | . . . | . . . | . . . |
| Delete | — | D | “p” | 254 | #C6 |
| “ ” | 32 | *32 | -blank- | 255 | #C8 |

As mentioned, control is provided through the control tone “D”. To request a text chat connection, a tone series “0DA” is used; to acknowledge a connection request, a tone series “0DB” is used. These two tone series are generated by the DTMF encoder 34 through a prolonged depressing of the “0” key of the keypad 32, which generates the initial “0” tone, the remaining “DA” or “DB” tones being generated automatically by the DTMF encoder 34. For example, during a conversation between two users, the first user simply holds down the “0” key for a predetermined time until the second user responds by pushing “0”, and establishing the text chat connection. A similar request/acknowledge system is used for disconnecting from a text chat connection and utilizes tone series “*D0” and “*D1” for request and acknowledgement respectively. Both of these request/acknowledge systems are supported by the microcontroller 44, which triggers corresponding audio or visual signals (such as emitting an audible tone to the user alerting them to an incoming chat request). It should be noted that while connecting and disconnecting from a text chat connection happens during an existing conventional voice connection, connection and disconnection steps are required to enable and disable tone series generation and recognition at the DTMF encoder 34 and the DTMF decoder 40. When a user is entering text, other control tones used include the “A” tone for moving a text-entering cursor left among an entered string of text, the “B” tone for moving the cursor right, the “C” tone for deleting the previously entered character, and the “D” tone alone for deleting the current character.

The radio transmitter 36 receives DTMF tone signals from the DTMF encoder 34 and modulates them into a radio signal, and further transmits the radio signal to the cellular base station 16 or directly to another mobile phone over a typical voice connection. After receiving radio signals, the radio receiver 38 demodulates the radio signals into audio data. Any DTMF tone signals in the radio signal are demodulated as such and sent to the DTMF decoder 40.

The DTMF decoder 40 receives DTMF tones from the radio receiver 38, decodes the DTMF tones referencing the character encoding and control scheme stored in the microcontroller 44, and outputs corresponding character codes to the LCD 42. The character codes output by the DTMF decoder 40 can be binary representations of the ASCII character codes. For example, if the DTMF decoder 40 receives a tone series “*121”, it will output a “y” character code (such as “01111001”=121) to the LCD 42.

The LCD 42 receives character codes from the DTMF decoder 40 and outputs characters corresponding to these codes. A chat-type window format is used on the LCD display 42 to simultaneously display received and sent text. The upper region 42a of the LCD 42 is used to display received text and the lower region 42b is used to echo typed text. For example, as shown in FIG. 2, the LCD 42 of the mobile phone 12 displays the text string “HELLO” as typed on the phone 12 in the lower region 42b, and the text string “HOW AR” as received from the mobile phone 14 in the upper region 42a.

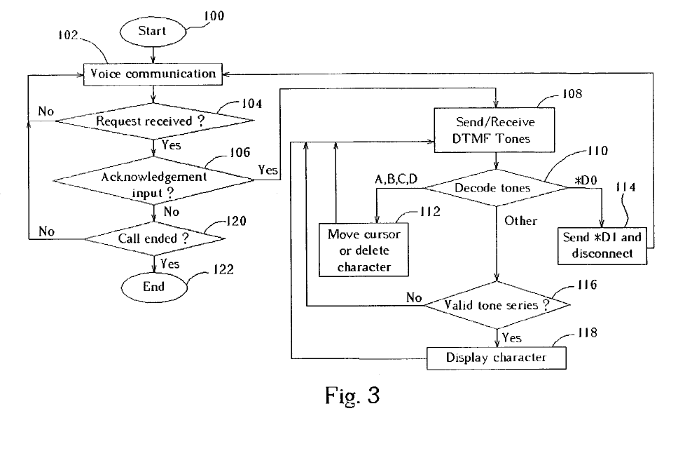

Please refer to FIG. 3 showing a flowchart illustrating the method of communicating a text message between the mobile phones 12, 14 according to the present invention. The flowchart of FIG. 3 is described as follows with reference to FIG. 2.

Step 100: Start;

Step 102: A voice connection is established between the two mobile phones 12, 14, allowing users to communicate verbally;

Step 104: The DTMF decoders 40 of the mobile phones 12, 14 continually listen for the text chat request DTMF signal of “0DA”. If the request “0DA” has been received go to step 106, if not, return to step 102;

Step 106: The DTMF decoder 40 has received the text chat request. Has the user accepted the request by pressing the “0” key on the keypad 32 to return a DTMF tone of “0DB”? If acknowledgement has been sent go to step 108, if the request has been ignored or denied, go to step 120;

Step 108: The keypad 32, the DTMF encoder 34, and the radio transmitter 36 are used to send DTMF tones. Characters input through the keypad 32 are echoed to the lower region 42b of the LCD 42. The radio receiver 38 receives radio signals including DTMF tones that are sent to the DTMF decoder 40;

Step 110: The DTMF decoder 40 decodes the received DTMF tones. If a received DTMF tone series is a single “A”, “B”, “C”, or “D” tone, go to step 112; if a series tones matching “*D0” is received, go to step 114; when other tones series are received go to step 116;

Step 112: The DTMF decoder 40 has detected a move cursor or delete control tone. The microcontroller 44 coordinates the text inputting application to move the cursor and/or to delete characters appropriately;

Step 114: The DTMF decoder 40 has detected the end text chat control tone “*D0”. The microcontroller 44 controls the DTMF encoder to output the corresponding acknowledge disconnect tone series “*D1”, and ends the text chat mode putting the mobile phone 12, 14 back into the voice communication mode;

Step 116: The DTMF decoder 40 references the character encoding and control scheme in the microcontroller 44 to determine if the tone series represents a character. Any valid tone series (see Table 2 for examples) causes the DTMF decoder 40 to output a corresponding character code to the LCD 44. An invalid tone series is one that is not stored in the microcontroller 44 as part of the character encoding and control scheme. If the received tone series is valid go to step 118, if not, return to step 108;

Step 118: The LCD 44 displays the character corresponding to the decoded tone series in the upper region 42a;

Step 120: Has the current voice call been terminated by, for example, a hang up signal? If the call has been disconnected go to step 122, if not, return to step 102;

Step 122: End.

In the process above, DTMF tones can be transmitted and received simultaneous with voice communication as both are on the same channel, the request and acknowledgement steps 104 and 106 supporting a mode change in the mobile phones 12, 14 and activating a suitable text entry program. In step 110 the DTMF decoder 40 has optimized logic for decoding continuous series of DTMF tones, processing tones serially using the “A”, “B”, “C”, “D”, “*”, and “#” tones as triggers.

Referring to FIG. 2, an example of text messaging with the present invention is now described. A user of the mobile phone 12 (first user) calls and connects with a user of the mobile phone 14 (second user). The first and second users initially talk via the established voice connection. The first user then desires to send a text message to the second user and initiates this by holding down the “0” key on the keypad 32 of the mobile phone 12 sending the “0DA” chat request signal to the mobile phone 14. The second user replies to the chat request by pressing the “0” key on the keypad 32 of the mobile phone 14 sending the “0DB” chat acknowledge to the first mobile phone 12. Each mobile phone 12, 14 then sets up the DTMF encoder 34 and decoder 40, loads the text entry program, and configures the LCD 42 into top and bottom regions 42a, 42b as shown in FIG. 2. The first user then enters the letter “H” into their phone 12 by depressing the “4” key twice and waiting for a time-out. In the mobile phone 12, the entered “H” is displayed in the lower region 42b of the LCD 42, and encoded by the DTMF encoder 34 into a tone series “*72” that is then transmitted to the mobile phone 14. In the mobile phone 14, the DTMF decoder 40 decodes the tone series “*72” as an “H”, which is then displayed in the upper region 42a of the LCD 42. Shortly after, the first user types “ELK[Backspace]LO” that is encoded and transmitted as a tone series “*69*76*75C*76*79”, which is received, decoded, and displayed on the mobile phone 14 effectively as “ELLO” completing the greeting “HELLO”. Text is sent from the second user to the first in an identical manner, simultaneously character-by-character. Thus, a text chat session occurs between the first and second users. After a while, the second users ends the chat session by holding down the “0” key of the mobile phone 14 sending the request disconnect signal “*D0” to the first user”s mobile phone 12, which responds with the confirmation signal “*D1”. At this time, both phones 12, 14 are still connected and the voice conversation between the first and second users can resume.

Generally, while the method above has been described as a character-by-character text chatting method, sending and receiving one-way messages, where a sting of text is first entered and then transmitted as DTMF tones, are also possible. Furthermore, the present invention can be readily applied to other devices such as conventional telephones and two-way radios.

In contrast to the prior art, the present invention provides a method and mobile phone structure for text messaging and text chat that do not require a specialized messaging center and a separate data channel. The present invention uses a DTMF tone text-encoding scheme and a DTMF decoder to realize quick and reliable text communication over a voice channel.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for communicating a text message between wireless communications devices, the method comprising:
selecting at least a text character with a first communications device;
transmitting a series of dual tone multi-frequency (DTMF) tones corresponded to the selected character by a predetermined character encoding scheme from the first communications device to a second communications device through radio transmission;
correlating the series of DTMF tones received at the second communications device to the selected character referencing the predetermined character encoding scheme; and
displaying the selected character on a display device of the second communications device.

2. The method of claim 1 further comprising:
assigning a series of DTMF tones to each character of a character set to generate the predetermined character encoding scheme; and
storing the predetermined character encoding scheme in a memory of the first communications device and in a memory of the second communications device.

3. The method of claim 2 wherein each character of the character set is assigned a unique series of three DTMF tones.

4. The method of claim 3 wherein the character set is the ASCII standard character set.

5. The method of claim 1 further comprising:
requesting a text chat mode between the first and second communications devices by sending a series of DTMF tones representing a chat request from the first communications device to the second communications device; and
acknowledging and initiating the text chat mode by sending a series of DTMF tones representing a chat acknowledgement from the second communications device to the first communications device.

6. The method of claim 5 further comprising:
requesting disconnection of the text chat mode between the first and second communications devices by sending a series of DTMF tones representing a chat disconnect request from the first communications device to the second communications device; and
acknowledging and initiating disconnection of the text chat mode by sending a series of DTMF tones representing a chat disconnect acknowledgement from the second communications device to the first communications device.

7. The method of claim 1 wherein the predetermined character encoding scheme further corresponds a character delete command to a unique series of DTMF tones, the method further comprising deleting a character from the display device of the second communications device when said unique series of DTMF tones is received and correlated at the second communications device.

8. The method of claim 1 wherein the predetermined character encoding scheme further corresponds several cursor move commands to several unique series of DTMF tones, the method further comprising moving a cursor on the display device of the second communications device according to one of said several unique series of DTMF tones being received and correlated at the second communications device.

9. The method of claim 1 wherein the first and second communications devices are each a mobile phone or a personal digital assistant (PDA).

10. A communications device capable of sending and receiving text messages comprising:
an input device for accepting input of text characters;
a dual tone multi-frequency (DTMF) encoder connected to the input device for generating a series of DTMF tones according to at least a character and a predetermined character encoding scheme;
a radio transmitter connected to the DTMF encoder for modulating the series of DTMF tones into a radio signal and transmitting the radio signal to another communications device;
a radio receiver for receiving other radio signals from other communications devices and demodulating DTMF tones from the other radio signals;
a DTMF decoder connected to the radio receiver for decoding the DTMF tones into characters according to the predetermined character encoding scheme; and
a display device connected to the DTMF decoder for displaying the decoded characters.

11. The communications device of claim 10 further comprising a microcontroller connected to the input device, the DTMF encoder, the radio transmitter, the radio receiver, the DTMF decoder, and the display device for controlling said components and for storing the predetermined character encoding scheme.

12. The communications device of claim 111 wherein the microcontroller is capable of responding to control commands decoded by the DTMF decoder, said commands being encoded as DTMF tones and stored in the predetermined character encoding scheme.

13. The communications device of claim 12 wherein the control commands include connection and disconnection commands for the input device, the DTMF encoder, the DTMF decoder, and the display device; and cursor movement and character delete commands for the display device.

14. The communications device of claim 10 wherein the input device comprises a 12-key telephone keypad.

15. The communications device of claim 10 wherein the display device comprises a liquid crystal display (LCD) capable of providing a split screen view of both input and received characters.
